(19) United States
(12) Patent Application Publication
(10) Pub. No.: US 2019/0291185 A1
(43) Pub. Date: Sep. 26, 2019

(54) POWDERED MATERIAL PREFORM AND PROCESS OF FORMING SAME

(71) Applicant: Temper IP, LLC, Rockford, MI (US)

(72) Inventors: William C. Dykstra, Rockford, MI (US); Luke A. Martin, Wyoming, MI (US)

(21) Appl. No.: 16/431,125

(22) Filed: Jun. 4, 2019

Related U.S. Application Data
(63) Continuation of application No. 15/314,972, filed on Nov. 30, 2016.
(60) Provisional application No. 62/134,063, filed on Mar. 17, 2015.
(60) Provisional application No. 62/006,393, filed on Jun. 2, 2014.

(51) Int. Cl. B22F 5/00; B22F 3/04; B22F 3/16; B22F 3/115; B22F 3/105; B22F 3/02; B33Y 80/00; B33Y 70/00; B33Y 10/00; F16C 7/02; B22F 1/00

(52) U.S. Cl. CPC B22F 5/00; B22F 3/04; B22F 3/16; B22F 3/115; B22F 3/1055; B22F 3/02; C22C 2026/002; B33Y 70/00; B33Y 10/00; F16C 7/02; B22F 1/0003; F16C 2220/20; B33Y 80/00

(57) ABSTRACT

A powdered material preform includes a pressed powdered metal or other powdered material, where the preform is processed and sealed so that a skin or shell is formed at the outer surface of the preform (such as via melting an outer layer or surface of the preform or via adding an outer layer around the preform or via a combination thereof), with an inner portion of the preform comprising pressed powdered material. The skinned preform may comprise a shape that is generally similar to that of a final product or part to be formed, or may simply comprise a puck or shape of approximately the same mass of the shape being formed, and the skinned preform is suitable for use in subsequent densification and/or consolidation processes or combinations thereof to form the final, fully processed part.

### CROSS REFERENCE TO RELATED APPLICATIONS

The present application is a continuation of U.S. patent application Ser. No. 15/314,972, filed Nov. 30, 2016, which is a 371 national phase filing of PCT Application No. PCT/US2015/033236, filed May. 29, 2015, which claims the filing benefits of U.S. provisional application Ser. No. 62/134,063, filed Mar. 17, 2015, and U.S. provisional application Ser. No. 62/006,393, filed Jun. 2, 2014, which are hereby incorporated herein by reference in their entireties.

### FIELD OF THE INVENTION

The present invention relates to forming a part using powdered material and, more particularly, to forming a powdered material preform for use in forming a fully processed part.

### SUMMARY OF THE INVENTION

The present invention provides a powdered material preform that comprises a pressed powdered material (such as, for example, a powdered metal, such as titanium, magnesium, steel, or aluminum or the like, or such as a powdered plastic or polymeric material, or a powdered ceramic material, or a multi-material powder with or without carbon fiber or carbon nanotubes or other strengthening agents, or the like), where the preform is processed and sealed so that a skin or shell is formed at the outer surface of the preform (such as via melting an outer layer or surface of the preform (such as by laser, plasma, electron beam, tungsten-electrode inert gas (TIG) arc, or induction, or the like) or via adding an outer layer around the preform (such as by 3D printing) or via a combination thereof), with an inner portion of the preform comprising pressed powdered material. The skinned preform may comprise a shape that is generally similar to that of a final product or part to be formed, or may simply comprise a puck or shape of approximately the same mass of the shape being formed, and the skinned preform is suitable for use in subsequent densification and/or consolidation processes or combinations thereof to form the final, fully processed part.

According to an aspect of the present invention, a powdered material is pressed into a form, using one or more processing steps, and then sealed or “skinned” (which can be accomplished by one or a combination of (i) melting the outer surface of the pressed powdered material preform, (ii) melting a material onto the outer surface of the preform, or (iii) encasing the preform), where that outer material may be the same material as the powdered inner material or may be another material, to provide a seal or skin or shell around the powdered form. The skinned preform may then be sealed and strengthened so as to be suitable for further processing (such as via pressing the preform, compressing the preform, densifying the preform, or a combination thereof to consolidate and densify the material) to make the fully processed part, with the skin and powdered internal portion of the preform combining or consolidating to form the fully processed part during the consolidation and/or densification process.

Optionally, before, during, or after the skinning process, a vacuum may be used to draw out contaminants from the powder, and optionally the internal powdered may be purged with an inert gas prior to performing and/or applying the skin to the surface, which may then be sealed within the outer skin or shell, which may be left in place or removed by applying a vacuum. If the preforming, sealing, or skinning process occurred in a vacuum, there may be no need to purge the inside of the preform, because it would already be in a vacuum (for example, such would be the case with an electron beam skinning process, because an electron beam processing is done in a vacuum). If the puck is sealed with some process gas or contaminants inside, such as if the puck is sealed in less than a perfect vacuum, sealed with a process gas, such as argon, or sealed under atmospheric conditions, it may take several (such as more than one and less than ten) purging cycles to get all or substantially all of the contaminants out of the sealed puck (for example, repeating the purging process steps using an inert gas, such as argon or even a gas such as nitrogen or the like, whereby, for example, a process gas, like argon, goes in, then a vacuum is applied to draw the gas and contaminants out, then argon in, then vacuum, etc.). The finished skinned part may have a tube, vent, valve, or port that may be used to create a vacuum in the interior of the skinned preform and to purge the preform with the inert gas, whereby the tube, vent, valve, or port may be crimped or otherwise closed to seal the preform when the vacuum/purging process is complete. The tube, vent, or port may be broken off or otherwise removed, or may become part of the final finished part (because it may be made from the same material as the finished part, such as titanium).

Therefore, the present invention provides a preform blank (and method of making same) that comprises a pressed powdered material core (such as pressed metal or the like) and an outer skin or layer that encases and seals the pressed powdered material core. The preform blank thus provides a powdered material element or blank that can be handled and shipped or transported from its manufacturing location to another process or location where the preform blank may be further processed to form the final blank. The present invention thus provides a preform blank that is suitable for further processing to a final product, while providing such a blank that is durable so that the blank can be handled and moved to another location without breakage or damage of the blank. Thus, the present invention allows for manufacturing of a powdered material preform blank at one location and further processing of the blank to the final product at another location, which may be remote from the first location.

These and other objects, advantages, purposes and features of the present invention will become more apparent upon review of the following specification in conjunction with the drawings.

### BRIEF DESCRIPTION OF THE DRAWINGS

FIG. 1 is a perspective view of a powdered metal preform before an outer skin is formed over the preform in accordance with the present invention;

FIG. 2 is a perspective view of the powdered metal preform of FIG. 1, after it has been sealed or skinned in accordance with the present invention;

FIG. 2A is a sectional view of the skinned preform of FIG. 2;

FIG. 2B is an enlarged sectional view of the area “B” in FIG. 2A;

FIG. 3 is a perspective view of the fully processed part formed from the skinned preform of FIG. 2;

FIG. 3A is a sectional view of the fully processed part of FIG. 3;

FIGS. 4 and 4A are perspective views of a preform die used for forming a powdered metal preform;

FIGS. 5 and 5A are perspective views of the preform die of FIGS. 4 and 4A, shown filled with raw powder;

FIGS. 6 and 6A are perspective views of the filled preform die of FIGS. 5 and 5A, shown as the metal is pressed to form the powdered preform;

FIG. 7 is an exploded perspective view of the die with the powdered metal preform being removed therefrom;

FIG. 7A is a perspective view of the powdered metal preform, shown partially skinned in accordance with the present invention;

FIGS. 8 and 8A are perspective views of the skinned preform;

FIGS. 9 and 9A are perspective views of the skinned preform as prepped for a purging process;

FIGS. 10, 10A, 10B are perspective views of the skinned preform, showing the process of removing contaminants from the preform;

FIGS. 11, 11A, 11B are perspective views of the skinned preform, showing the process of purging the preform with inert gas;

FIGS. 12, 12A, 12B are perspective views of the skinned preform, showing the process of sealing the preform;

FIG. 13 is a schematic showing a process of forming a skinned preform in accordance with the present invention and using the skinned preform for making a finished product;

FIG. 14 is a schematic of a process of forming a skinned preform, shown with the process steps occurring in a vacuum;

FIG. 15 is a schematic of another process of forming a skinned preform, shown with the first two process steps occurring in open atmosphere or in a controlled atmosphere, such as a process gas atmosphere, with the preform being purged of contaminants following the skinning or sealing process;

FIG. 16 is a perspective view showing a pass-through induction coil used to create a skin around a preform by melting the outside surface in accordance with the present invention;

FIG. 17 is a perspective view showing a pancake induction coil used to create a skin around a preform, with the coil being moved (such as robotically moved) under and/or around the preform;

FIG. 18 is a perspective view showing a pancake induction coil with a flux concentrator;

FIG. 19 is a perspective view showing filling an induction die with powder in accordance with the present invention;

FIG. 20 is a perspective view showing compressing the powder in the die and using the induction coil to create the skinned puck or preform in accordance with the present invention;

FIG. 21 is a perspective view showing removal of the completed puck or preform from the die, with the completed puck or preform comprising, for example, powdered titanium, magnesium, aluminum or a plastic or a ceramic or a multi-material powder with or without carbon fiber or carbon nanotubes or other strengthening agents or the like;

FIG. 22 is a perspective view showing a powdered material preform with a small induction coil with a flux concentrator that is used to create a skin around the powdered material of the preform in accordance with the present invention;

FIG. 23 is a perspective view showing a powdered material preform with a small induction coil without a flux concentrator that is moved over the powdered material preform to create a skin in accordance with the present invention; and

FIG. 24 is a perspective view showing a powdered material preform with an iron cored induction coil without a flux concentrator that is moved over the powdered material preform to create a skin over the powdered material preform in accordance with the present invention.

### DESCRIPTION OF THE PREFERRED EMBODIMENTS

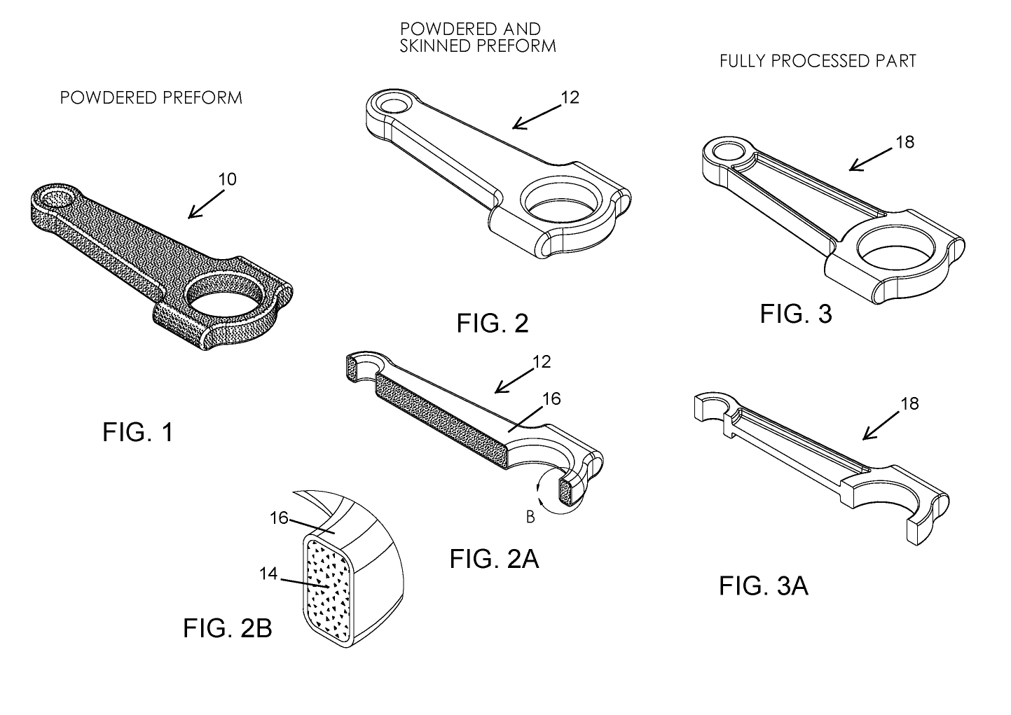

Referring now to the drawings and the illustrative embodiments depicted therein, the present invention provides a process of forming a sealed or skinned preform 12 of a powdered material 14, such as a powdered metallic or nonmetallic material, such as titanium, magnesium, steel alloys, aluminum, graphene, ceramics, plastics, or the like (FIGS. 1-3A). The powdered material or metal, metal alloy or multi-material is pressed into a shape 10 (such as into a shape that generally corresponds to the final shape of the product or part to be formed) and is sealed or skinned (such as by melting the outer layer or surface of the pressed powdered metal preform, or such as by using additive manufacturing processes, such as 3D printing technologies, or a combination thereof). The skinned powdered material (such as metal) preform 12 is then used in a consolidation and/or densification process (such as hipping, sintering, hot pressing, thermal cycling, magnetic cycling, or the like) to form the final product 18 (FIGS. 3 and 3A).

The skinned powdered material preform 12 or blank or puck is a sealed, contaminant free, preform used in powdered material consolidation and/or densification processes such as hot isostatic pressing, sintering, thermal cycling, magnetic phase change cycling, a combination of thermal cycling and magnetic phase change cycling or the like. The puck permits commercialization and mass production of powdered metallic or non-metallic components to a scale that is not otherwise achievable. This feat is possible because the sealed or skinned preform or puck is free of gaseous contaminants on the inside and sealed via an outer layer to prevent recontamination. This allows for easy handling as well as enhanced processing for batch or assembly line production styles. In addition, the skinned powdered metallic preform 12 may have a selected material placed inside of the puck, such as a gas (such as nitrogen, argon or the like), a solid (such as graphene or the like), or liquid (such as liquid nitrogen, water or the like). For example, grain growth in the finished product may be a concern, and therefore, nitrogen at a density level between 0 and 5 atmospheres of pressure may be placed inside the sealed puck to alter the grain growth.

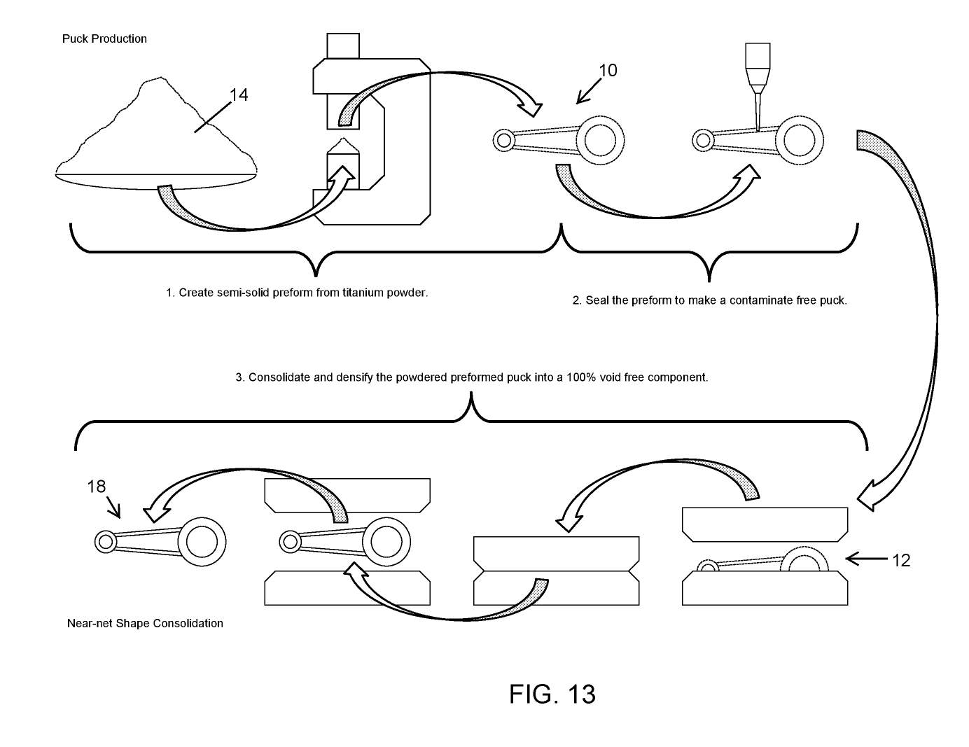

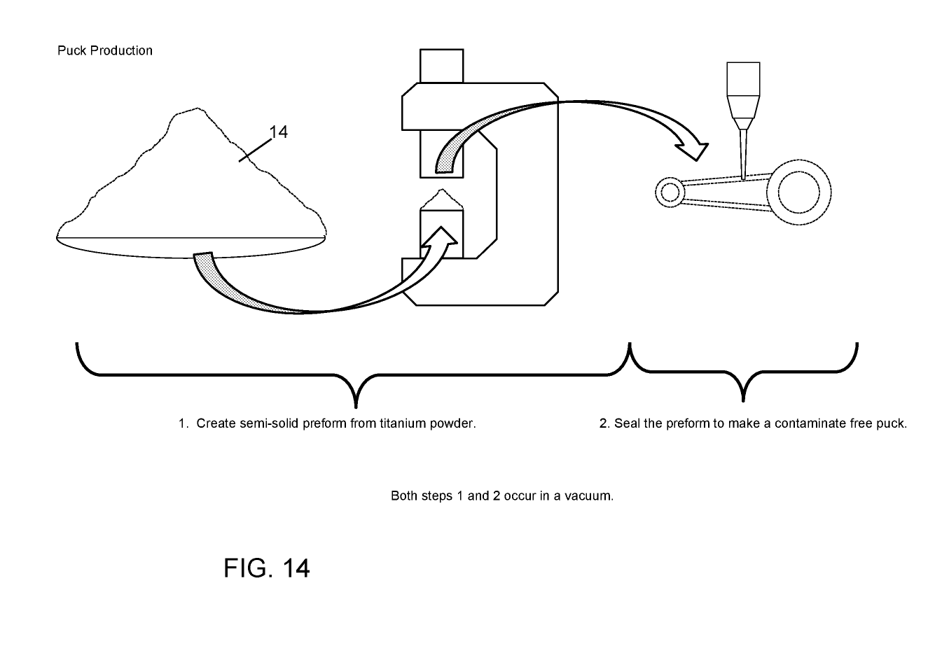

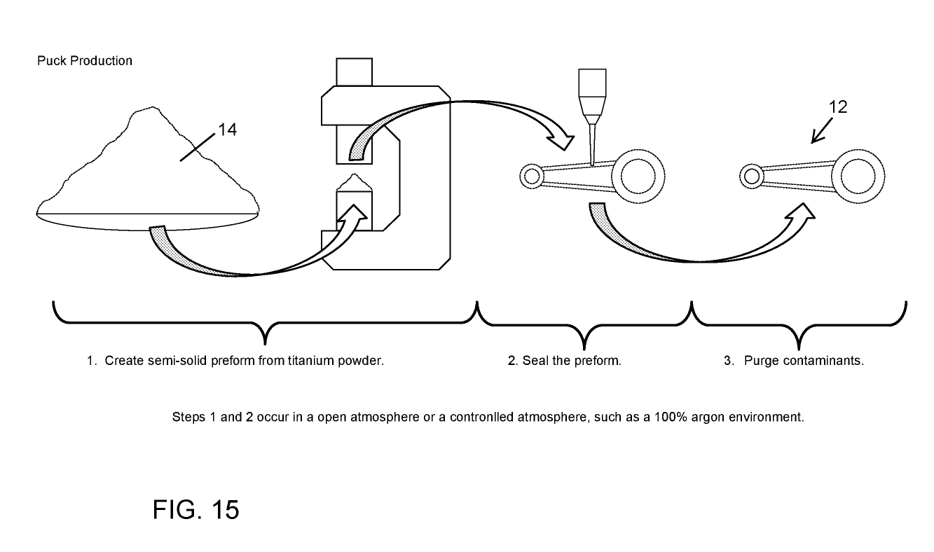

The powder material 14 is premeasured and compacted into a semi-solid using cold compaction, die pressing, or similar operation to produce a powdered blank 10 (see FIGS. 1, 4-7 and FIGS. 13-15). The powdered blank 10 has a makeup similar to a sedimentary type of solid and is made up of powdered material similar to the way sedimentary rocks are made up of granules of sand. The powdered blank 10 may comprise any suitable powdered material, such as powdered metal, plastic, ceramic, composite, or any combination of powders. The powdered blank 10 is shaped and/or distributed to allow for processing into a near-net shape component.

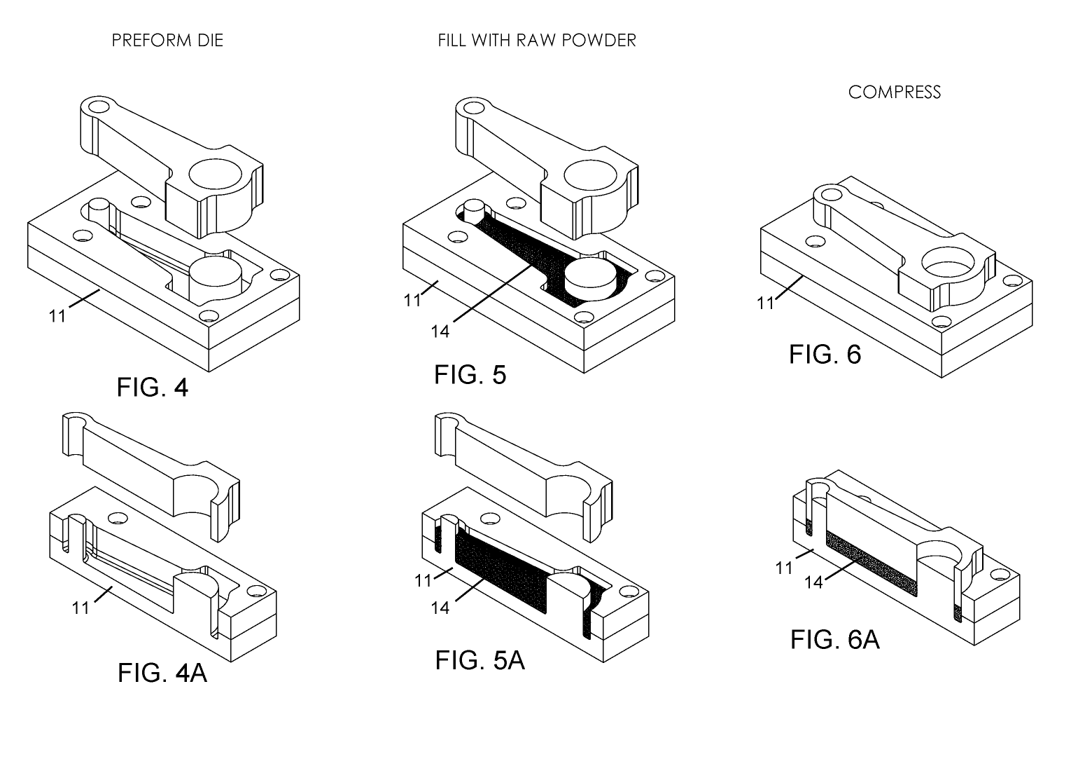

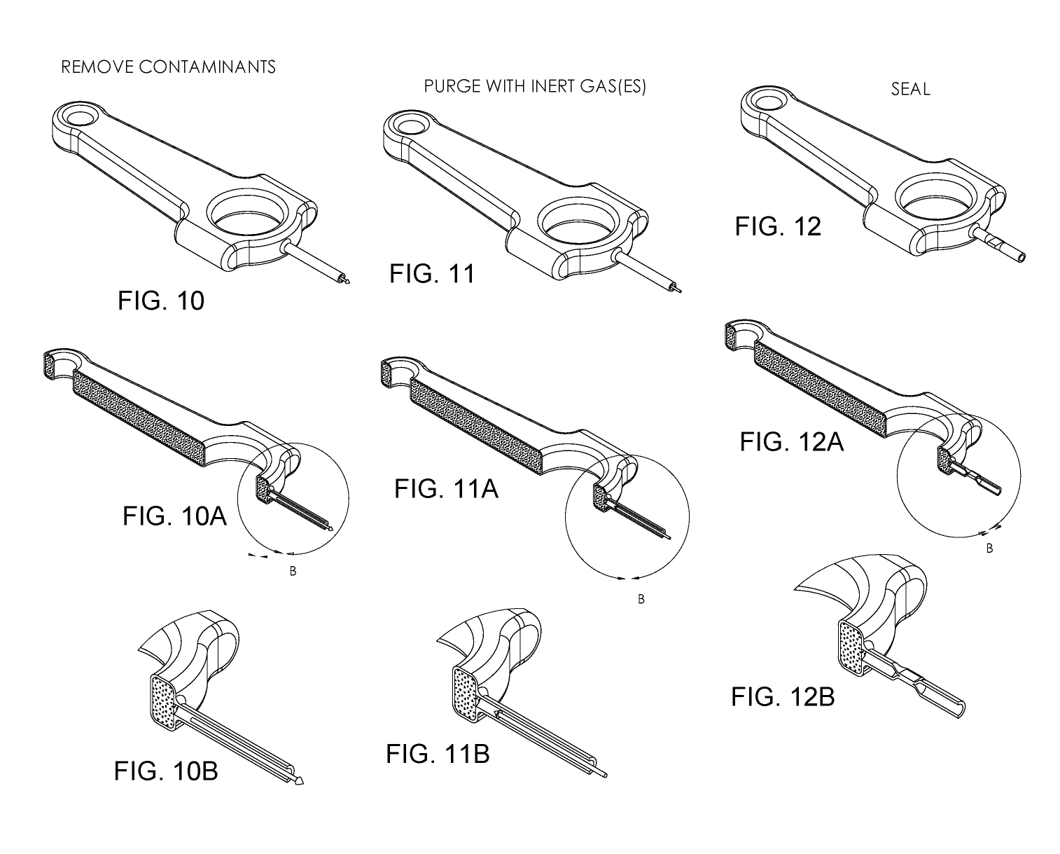

After being pressed into the preform shape (such as in a die 11, as shown in FIGS. 4-7), the powdered blank 10 is then skinned and purged or vacuumed and sealed to provide a sealed blank 12 or preform (see FIGS. 2, 2A, 2B and 8-12B). In a preferred embodiment, both the compaction and sealing or skinning steps required to make a puck are performed in a near or full vacuum or otherwise controlled atmosphere.

### Powder Compaction Step

The powder compaction step, as shown in FIGS. 4-7, operates to press or compact the powdered material 14 into a preform shape. The compacted powdered shape or preform 10 comprises powdered material and is not sealed or skinned or encased, and thus is not robust or strong and may not be suitable for further handling and processing, unless carefully handled and moved from one step to the next. The compaction step may be performed in a controlled atmosphere, such as in a vacuum, such that contaminants are not present in the compacted powdered metal preform or shape, materials, such as titanium or alloys of titanium powders.

This is important because, for materials such as titanium, contaminants, such as oxygen, hydrogen, nitrogen, or other contaminants, may react with the powder during the skinning processing step or the densification processing step, which could negatively alter the final chemistry and material properties. On the other hand, certain elements, such as carbon, argon, helium, nitrogen, or the like, may react with the powder during the skinning processing step or the densification processing step and could positively alter the chemistry and material properties. Similarly, the atmosphere in which the puck is produced may have no effect on subsequent processing or part performance, depending on material type.

### Puck Sealing Step

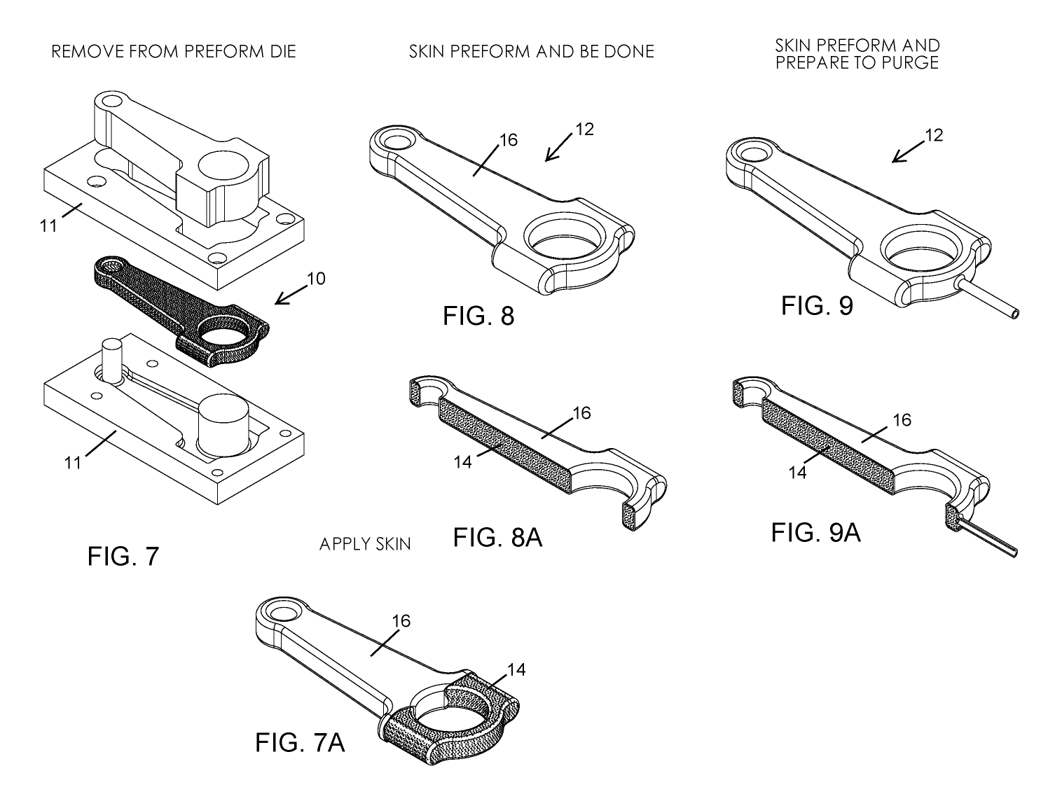

Before leaving the controlled atmosphere, the puck is preferably sealed, as shown in FIGS. 8 and 8A, or may be purged and sealed in a secondary processing step, as shown in FIGS. 9-12B. The idea is to fuse or coat the outer layer of the puck to create a seal. The seal 16 may be established or generated by a laser, an electron beam, an induction heating field, an ultrasonic heater, microwave heating, electrical resistance heating, electrical tungsten-electrode inert gas (TIG) arc, radiant heat, a plasma flame, thermal spray, flame, deposition, encasement, or may be sealed by using an additive manufacturing process using laser, electron beam, plasma, induction heat, or a combination of melting of the surface and using additive manufacturing processing or a combination thereof or similar technology. As shown in FIGS. 7-8A, the sealing process creates a skin 16 or encasement or sealing surface around the powdered blank 10. The skin 16 serves multiple purposes, one of which is to contain the powder 14. Because the sedimentary type solid may be easily crumbled, the skin 16 of the present invention provides or creates a robust casing and (because it may be formed from the outer layer or layers of the powdered material itself) ensures that mass is neither added to nor subtracted from the puck during the subsequent processes. It is contemplated that the skin 16 may comprises a single or multiple part sub-assembly made by investment casting, thixotropic molding, sintering, adiabatic processing, consolidation processing, densification processing, or other conceivable processing techniques.

Another purpose of the skin 16 is to prevent gaseous or other contaminants from entering the puck. The sealing operation may be performed before the semi-solid puck leaves a controlled atmospheric environment. This ensures that any gas present or absent in the controlled environment cannot penetrate or escape the seal of the puck. The implication is that once the skin 16 is formed around the puck and the puck is fully sealed, the puck can be removed from the controlled atmosphere and put into an uncontrolled atmosphere without the risk of introducing unwanted contaminants to the preformed powder 14. This means the preformed and contaminant free puck can be easily handled in any environment without compromising the integrity of the powder 14 or the final product 18.

Alternatively, the loose material can be formed or compacted into the preformed blank 10 in a gaseous environment (such as air, nitrogen, argon and/or the like depending on what material is being processed) and then kept in the same gaseous environment or changed to a new gaseous environment, sealed with a skin 16 as described above, and then purged of a process gas or contaminants and then a new process gas can be introduced into the sealed puck for the consolidation and/or densification process step and resealed. This would achieve the same goal as described above but allow for the preform blank to be made in and/or enter into an uncontrolled and/or ambient/atmospheric environment before being sealed.

Thus, due to the difficulty of the preparation work to prepare powdered titanium (or other metals, non-metals or multi-materials) for a consolidation process, the present invention provides enhanced processing by creating a skinned preform of the powdered material. For example, one of the difficulties of powdered titanium parts is that the powdered titanium has to be consolidated in special environments. By providing a prepackaged, sealed preform or blank or “puck”, the puck or preform of the present invention can be inserted into any consolidation process, thus saving processing steps and saving time and money, while providing a quality end product.

The present invention thus provides a process step between making a compressed or formed powdered blank 10 or preform, and the densification of the powdered blank into a near net shaped part. The preformed puck consists of powdered material that is compacted into a shape (a compacted block that can be handled but that may be fragile) that is then sealed (such as by melting its outer surface), which then makes it very durable. The sealed preform 12 thus can be readily used in various processes. For example, the sealed or skinned preforms can be placed into a hopper of an automated system for further processing, be preheated prior to a subsequent densification process, or be pre-densified.

The compacting and melting of the outer preform surface can be done in a vacuum, in a controlled environment, or in an uncontrolled environment, depending on the compacting and melting (skinning) processes selected, the material to be processed, and quality level needed of the finished component. In addition, it may be desirable to have a controlled environment for the skinning operation, and/or a controlled environment (or a vacuum) for the inside of the skinned puck. For example, for titanium the preferred environment inside the puck would be a near perfect vacuum with almost zero percent oxygen. Different titanium alloys, metals or multi-materials may require different environments.

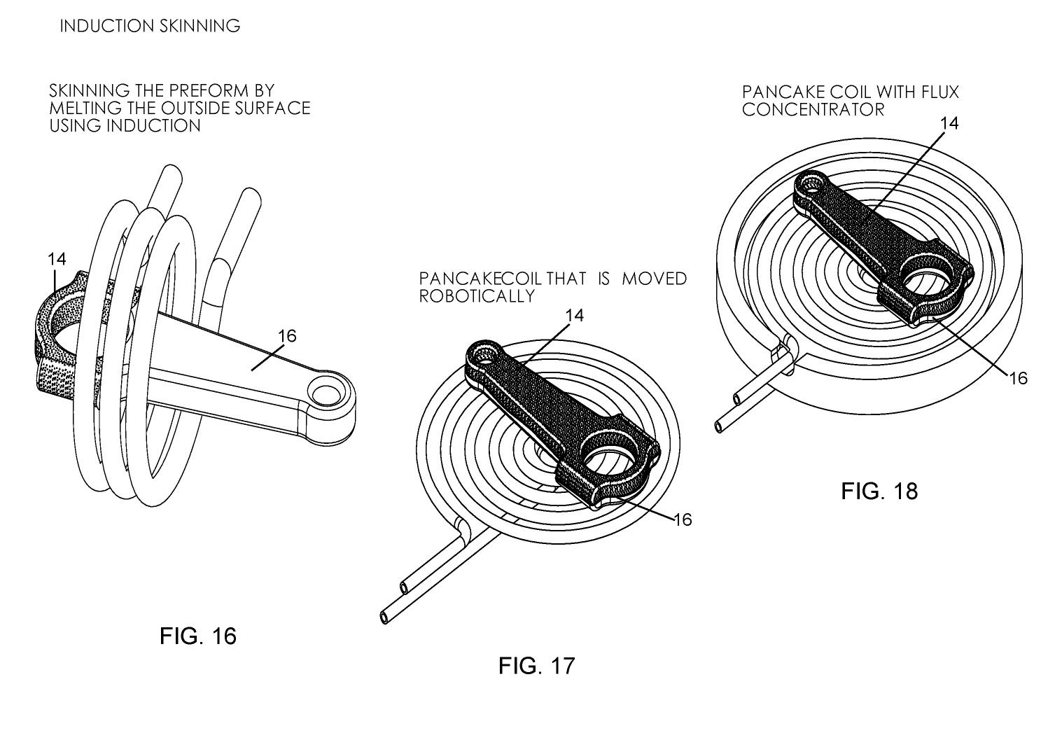

The present invention provides a process of forming a powdered material preform 10 (such as powdered titanium, magnesium, steel, aluminum, ceramic, or multi-material powders with or without carbon fiber or carbon nanotubes or other strengthening agents or the like) where the preform is processed and sealed so that a skin 16 or shell is formed at the outer surface of the preform 10. The present invention may also expand the processing and sealing of the preform to include induction as a method of creating the skin or shell, such as shown in FIGS. 16-24. In the case of titanium, the proposed method uses a very high frequency (between 30 Khz and 10,000 Khz, but more preferably between 500 Khz and 2,000 Khz) induction field to couple into and heat the individual grains of the powder material 14 at the surface of the pre-compacted puck 10, causing them to heat. The heat causes the grains to melt and coalesce, thereby creating a skin 16 or shell around the preform 10.

The proposed induction field would couple into the compacted titanium powder 14 at the surface of the preform 10. By selecting the appropriate induction heating frequency and power level, the outer grains of the preform can be targeted for heating. The heating would be limited to the surface or surfaces just below the exterior of the preform 10.

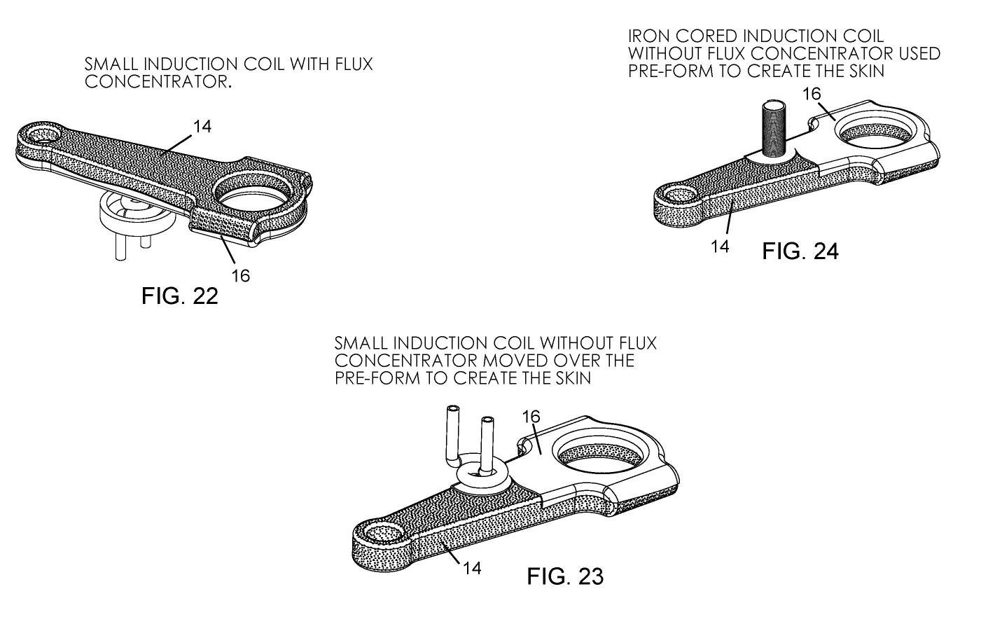

The heating is due to an induction field that is generated by an induction coil. The skin 16 can be produced by moving the preform through the induction field, wherein the induction coil remains stationary (see FIGS. 22 and 24), or by moving the induction coil, wherein the preform remains stationary (see FIG. 23). Other arrangements include, but are not limited to, applying the skin 16 or shell on all sides of the preform at once, applying the skin or shell where the preform is supported by a non-conductive or magnetically transparent material, such as a ceramic, non-ferrous metal, or other material that is transparent to the induction field.

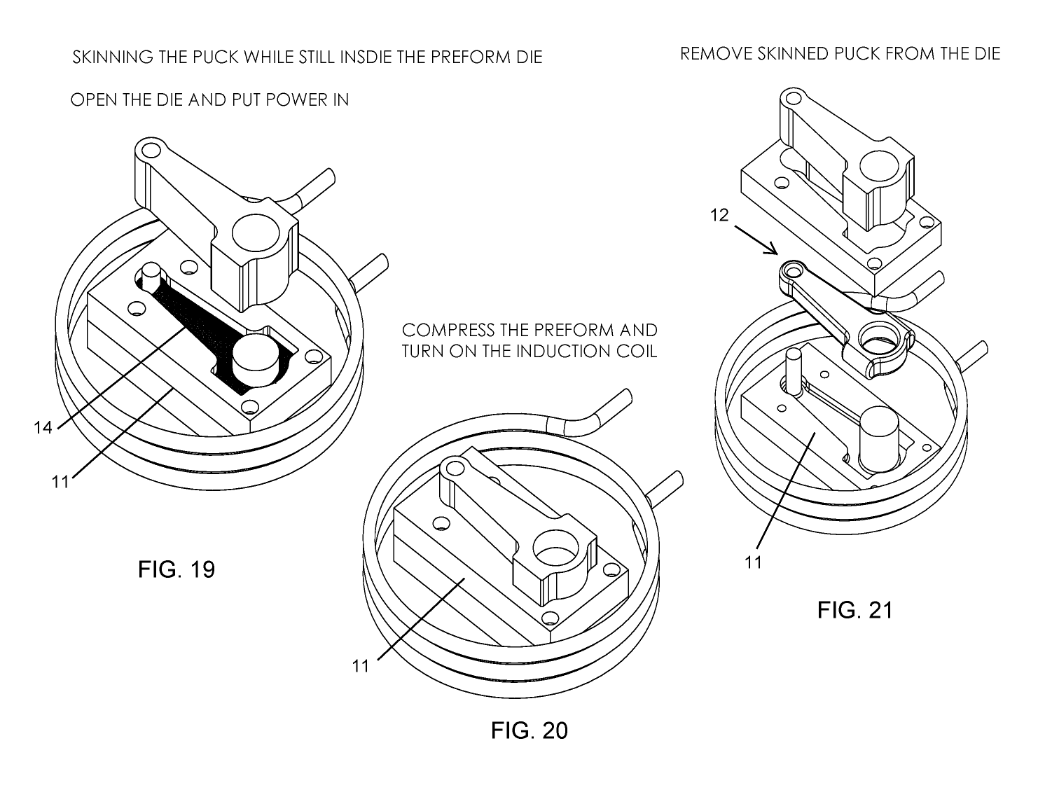

Alternatively, the induction process for applying the skin or shell can be accomplished while the preform is in the compaction die, as shown in FIGS. 19-21. Such a setup would process raw powdered material and preform it into a shape and create a skin or shell around the preform in a single operation.

Changes and modifications to the specifically described embodiments may be carried out without departing from the principles of the present invention, which is intended to be limited only by the scope of the appended claims as interpreted according to the principles of patent law including the doctrine of equivalents.

1. A preform blank comprising:
powdered material that is at least partially compacted to form a shape;
an outer surface that encases and seals the powdered material therein;
wherein the powdered material comprises one selected from the group consisting of (i) metal, (ii) plastic, and (iii) ceramic; and
wherein the outer surface comprises an outer surface established by encasing an outer portion of the powdered material.

2. The preform blank of claim 1, wherein the powdered material comprises metal powder.

3. The preform blank of claim 2, wherein the metal powder comprises at least one selected from the group consisting of titanium, magnesium, aluminum, nickel, and iron.

4. The preform blank of claim 1, wherein the preform blank is suitable for use in one selected from the group consisting of powder metallurgy processes, consolidation processes, and densification processes.

5. The preform blank of claim 1, wherein the powdered material is formed into a blank using one selected from the group consisting of cold compaction, die pressing, and isostatic pressing.

6. The preform blank of claim 1, wherein the powdered material comprises metal powder, and wherein the metal powder comprises at least one metal alloy comprising at least one selected from the group consisting of titanium, magnesium, aluminum, nickel, iron, and graphite.

7. The preform blank of claim 1, wherein the powdered material comprises at least one strengthening material.

8. The preform blank of claim 7, wherein the at least one strengthening material comprises at least one selected from the group consisting of carbon fiber, carbon nanotubes, Kevlar, ceramic, and glass.

9. The preform blank of claim 1, wherein the powdered material comprises at least one strengthening material comprising at least one selected from the group consisting of carbon fiber, carbon nanotubes, Kevlar, ceramic, and glass.

10. The preform blank of claim 1, wherein the preform blank is formed and sealed in a controlled environment.

11. The preform blank of claim 10, wherein the controlled environment comprises a near vacuum.

12. The preform blank of claim 10, wherein the controlled environment comprises an atmosphere composed of one or more gases comprising at least one selected from the group consisting of argon, hydrogen, and nitrogen.

13. The preform blank of claim 1, wherein the outer surface is generated by fusing additional powder around the preform blank using at least one selected from the group consisting of a laser, an electron beam, induction heating, ultrasonic heating, plasma flame, and electric arc.

14. The preform blank of claim 1, wherein the outer surface is generated by fusing the outer layers of powder that make up the preform blank using at least one selected from the group consisting of a laser, an electron beam, induction heating ultrasonic heating, plasma flame, and electric arc.

15. The preform blank of claim 1, wherein the outer surface is generated by a coating or deposition process comprising one selected from the group consisting of a thermal spray, welding, additive manufacturing, 3-D printing, and plating.

16. The preform blank of claim 1, wherein a material of the outer surface comprises at least one selected from the group consisting of a plastic, wax, paint, and metal.

17. The preform blank of claim 1, wherein the outer surface is generated before the preform blank is removed from a preforming die comprising one selected from the group consisting of a cold compaction die, a die pressing die, and an isostatic pressing apparatus.

18. The preform blank of claim 1, wherein the preform blank is further processed using pressure and at least one selected from the group consisting of thermal cycling and magnetic cycling.

19. The preform blank of claim 1, wherein the preform blank is purged of contaminants via a tube that establishes a passageway through the outer surface to the powdered material.

20. The preform blank of claim 1, wherein the outer surface is generated by coalescence of a surface or surfaces just below the outer surface of the powdered material.

21. The preform blank of claim 20, wherein the coalescence is due to an induction field generated at the preform blank.

22. A method of forming a preform blank comprising:
providing a powdered material that comprises one selected from the group consisting of (i) metal, (ii) plastic, and (iii) ceramic;
pressing the powdered material into a powdered preform shape; and
after the powdered material is pressed into the powdered preform shape, establishing an outer skin around the powdered preform shape to encase and seal the powdered preform shape to form a preform blank.

23. The method of claim 22, wherein the powdered material comprises metal powder.

24. The method of claim 23, wherein the metal powder comprises at least one selected from the group consisting of titanium, magnesium, aluminum, nickel, and iron.

25. The method of claim 22, wherein the preform blank is suitable for use in one selected from the group consisting of powder metallurgy processes, consolidation processes, and densification processes.

26. The method of claim 22, wherein pressing the powdered material into a powdered preform shape comprises using one selected from the group consisting of cold compaction, die pressing, and isostatic pressing.

27. The method of claim 22, wherein the powdered material comprises metal powder, and wherein the metal powder comprises at least one selected from the group consisting of metal alloy comprising at least one of titanium, magnesium, aluminum, nickel, iron, and graphite.

28. The method of claim 22, wherein the powdered material comprises at least one strengthening material.

29. The method of claim 28, wherein the at least one strengthening material comprises at least one of carbon fiber, carbon nanotubes, Kevlar, ceramic, and glass.

30. The method of claim 22, wherein the powdered material comprises at least one strengthening material comprising at least one selected from the group consisting of carbon fiber, carbon nanotubes, Kevlar, ceramic, and glass.

31. The method of claim 22, wherein establishing the outer skin around the powdered preform shape comprises establishing the outer skin in a controlled environment.

32. The method of claim 31, wherein the controlled environment comprises a near vacuum.

33. The method of claim 31, wherein the controlled environment comprises an atmosphere composed of one or more gases comprising selected from the group consisting of argon, hydrogen, and nitrogen.

34. The method of claim 22, wherein establishing the outer skin around the powdered preform shape comprises fusing additional powder around the powdered preform shape using at least one selected from the group consisting of a laser, an electron beam, induction heating, ultrasonic heating, plasma flame, and electric arc.

35. The method of claim 22, wherein establishing the outer skin around the powdered preform shape comprises fusing outer layers of powder that make up the powdered preform shape using at least one selected from the group consisting of a laser, an electron beam, induction heating, ultrasonic heating, plasma flame, and electric arc.

36. The method of claim 22, wherein establishing the outer skin around the powdered preform shape comprises coating or depositing the outer skin with one selected from the group consisting of a thermal spray, welding, additive manufacturing, 3-D printing, and plating.

37. The method of claim 22, wherein a material of the outer skin comprises at least one selected from the group consisting of a plastic, wax, paint, and metal.

38. The method of claim 22, wherein the outer skin is established around the powdered preform shape before the powdered preform shape is removed from a preforming die comprising one selected from the group consisting of a cold compaction die, a die pressing die, and an isostatic pressing apparatus.

39. The method of claim 22, further comprising processing the preform blank using pressure and at least one selected from the group consisting of thermal cycling and magnetic cycling.

40. The method of claim 22, further comprising purging the preform blank of contaminants via a tube that establishes a passageway through the outer skin to the powdered material.

41. The method of claim 22, wherein establishing the outer skin comprises coalescing a surface or surfaces just below the outer skin of the powdered material.

42. The method of claim 41, wherein coalescing the surface or surfaces comprises generating an induction field at the preform blank.
